(19) United States
(12) Patent Application Publication
(10) Pub. No.: US 2009/0047617 A1
(43) Pub. Date: Feb. 19, 2009

(54) MULTIPLE POSITION HAND-PIECE HOLSTER FOR A DELIVERY UNIT

(75) Inventors: James Terry Bush, Mooresville, NC (US); Jason W. Spencer, Tega Cay, SC (US); Austin Everett Unsworth, Ft. Mill, SC (US)

Correspondence Address: TRASK BRITT, P.O. BOX 2550, SALT LAKE CITY, UT, 84110, US

(73) Assignee: PELTON & CRANE, Charlotte, NC (US)

(21) Appl. No.: 11/837,916

(22) Filed: Aug. 13, 2007

(51) Int. Cl. A61C 1/14

(52) U.S. Cl. 433/28

(57) ABSTRACT

A multiple position tool receptacle may be incorporated within a medical delivery unit, such as a dental unit head, allowing for positioning of a hand-held device in one of two or more seats. The receptacle may include a switching device operatively coupled in the receptacle to “activate” the medical delivery unit upon removal of a hand-held device from any one of the receptacle's seats. A method of providing multiple hand piece positioning in a “holster” is also provided.

### FIELD OF THE INVENTION

The present invention relates to a hand piece receptacle for a delivery unit and, more particularly, to a multiple position hand piece receptacle for improved usability in an aseptic environment.

### BACKGROUND OF THE INVENTION

Enhanced medical care is promulgated by use of advanced medical equipment. The medical equipment is directed not only to improving the quality of care, but also toward procedural time savings while further reducing the anxiety or pain often times experienced by the patient. However, these desired factors may be inhibited by the need to maintain a sterile environment or are reduced by the physical limitations of the attending health care professional, both of which may increase the time to complete a given procedure. This can lead to increased anxiety to the patient or heightened pain exposure for the patient, either of which can ultimately reduce the overall quality of care. Although no logical reason for such increased levels of anxiety may exist, such anxiety is often unwanted. Other than reassurances from the dentist, the dentist's staff, and others offering encouragement, such anxiety is difficult to decrease. In some instances, the increased anxiety levels experienced by a patient in a dentist's office may also increase the blood pressure of the patient. Accordingly, it is desirable to not only improve medical equipment, but to improve the conditions under which the medical equipment is used while maintaining the sterile environment and or by reducing the resultant affects of the physician's physical limitations in working with the equipment in order to increase the quality of care.

A delivery unit is a type of medical equipment conventionally known for use in a dental office, as well as in other medical fields. The delivery unit is a structure that provides necessary tools and instruments readily available to the dentist, or the assistant. The delivery unit is used by the dentist under an aseptic or sterile environment, necessitating a particularly designed structure. For instance, the delivery unit typically encountered in the dental office is the dental unit head. The dental unit head provides an assortment of hand-held devices, such as dental air tools, cameras, syringes, vacuum accessories or ultraviolet light source that are needed to perform many dental procedures. Many of the hand-held devices are located in holsters or receptacles that form part of the outer edge of the unit head. In order to facilitate access and expedite use by the dentist, the receptacle typically includes a mechanical switch to activate or deactivate the hand-held device upon insertion and removal from the unit head. The dentist will position the unit head, with the hand-held devices located in their respective receptacles, in a location that will facilitate repeated access to the hand-held devices, not only to improve the expedience of the procedure, but also to lessen physiological stress on his own body. However, due to their design, positioning of the unit head is limited with conventionally known unit heads.

One type of holster or receptacle conventionally provided in a dental unit head offers a single fixed position and may include a switch for engagement with a hand-held device when inserted into the receptacle for activation thereof. Because the receptacle is typically mounted on an outer edge of the unit head, it includes a slot that allows for passage of a supply line that is coupled to the hand-held device. The supply line may include air, water or electricity that is necessary for the operation of the hand-held device. Receptacles having this single position configuration do not allow for ergonomic positioning of the hand-held device, which may lead to unnecessary fatigue or stress to the dentist. Further, the single position receptacle may interfere with other receptacles located adjacently nearby when placing other hand-held devices into their particular positions. Crowding of receptacles or the limited access resulting from a single access orientation of the receptacle can further complicate procedures for the dentist during placement or removal of a device. Accordingly, it would be desirable to provide a receptacle that permits the dentist to place a device in a more convenient position when replacing the hand-held device back into the receptacle. Moreover, it is desirable to provide a receptacle that also deactivates the hand-held device upon placement into the more convenient position.

Yet another kind of receptacle conventionally provided in a dental unit head offers a rotating position. The rotating receptacle allows a dentist to pivot or rotate the receptacle into a desired position by way of several moving parts. However, while improving the positioning of devices into the receptacle, the receptacle only allows for placement of the hand-held device into the single rotated position. While the rotated single position receptacle has attendant advantages over the fixed position receptacle, the multiple moving parts increase the likelihood of sepsis and reduce the ease of cleaning and disinfecting of the receptacle.

### BRIEF SUMMARY OF THE INVENTION

According to one embodiment of the invention, a dental tool receptacle comprises a first seat, a second seat adjacent to the first seat, and a slot for releasably receiving a hand-held device in one of the first seat or the second seat.

According to another embodiment of the invention, a delivery unit comprises a unit head, and one or more hand-held devices operatively supported by the unit head. At least one multiple position hand device receptacle is coupled to the unit head, with each multiple position hand device receptacle releasably receiving one of the one or more hand-held devices.

In yet another embodiment, at least one multiple position hand device receptacle may comprise a plurality of seats. One of the plurality of seats may be a first seat and another of the plurality of seats may include a second seat, with the second seat being adjacent to the first seat. A slot for releasably receiving a hand-held device is located in one of the plurality of seats.

A method of providing multiple hand piece positioning in a holster comprises providing a unit head, providing one or more hand-held devices operatively supported by the unit head, providing at least one multiple position hand device receptacle coupled to the unit head, and receiving one of the hand-held devices in a slot of one or more of the multiple position hand device receptacle(s).

Other advantages and features of the present invention will become apparent when viewed in light of the detailed description of the various embodiments of the invention when taken in conjunction with the attached drawings and appended claims.

### BRIEF DESCRIPTION OF THE SEVERAL VIEWS OF THE DRAWINGS

While the specification concludes with claims particularly pointing out and distinctly claiming that which is regarded as the present invention, the advantages of this invention can be more readily ascertained from the following description of the invention when read in conjunction with the accompanying drawings in which:

FIG. 1 shows a multiple position hand piece receptacle according to an embodiment of the invention;

FIG. 2 shows a partial view of a multiple position hand piece receptacle having a dental tool in a second position in accordance with a particular embodiment of the invention;

FIG. 3 shows a partial front view of a multiple position hand piece receptacle having a dental tool in a first position in accordance with another embodiment of the invention;

FIG. 4 shows a partial side view of a multiple position hand piece receptacle in accordance with another embodiment of the invention; and

FIG. 5 shows a partial top view of a multiple position hand piece receptacle in accordance with yet another embodiment of the invention.

### DETAILED DESCRIPTION OF THE INVENTION

According to particular embodiments of the invention, a multiple position hand device or tool receptacle may be incorporated within a medical delivery unit, such as a dental unit head, allowing for positioning of a hand-held device in one of two or more seats. The receptacle may include a switching device operatively coupled in the receptacle to “activate” the medical delivery unit upon removal of a hand-held device from any one of the receptacle's seats.

According to other embodiments of the invention, a multiple position tool receptacle is provided allowing for positioning of a hand-held device in more than one position. The receptacle includes a surface that is a single continuous material (e.g., unitary or solid materials) for improved asepsis or sterility. The surface having the multiple positions in the receptacle may include a tapered pattern or guide to better facilitate “holstering” when inserting a hand-held device into the receptacle.

In other embodiments of the invention, the multiple position hand device receptacle may be incorporated with a delivery unit that can be located by the dentist by position, such as a delivery unit located upon a bench, a cart or an articulating arm. The receptacle allows the dentist to place the device in one or more convenient position(s) when replacing the hand-held device back into the receptacle.

In still other embodiments of the invention, there is provided a method of positioning a hand piece in multiple angles within a “holster” or receptacle, and further deactivating the hand-held device upon placement of the same into the receptacle.

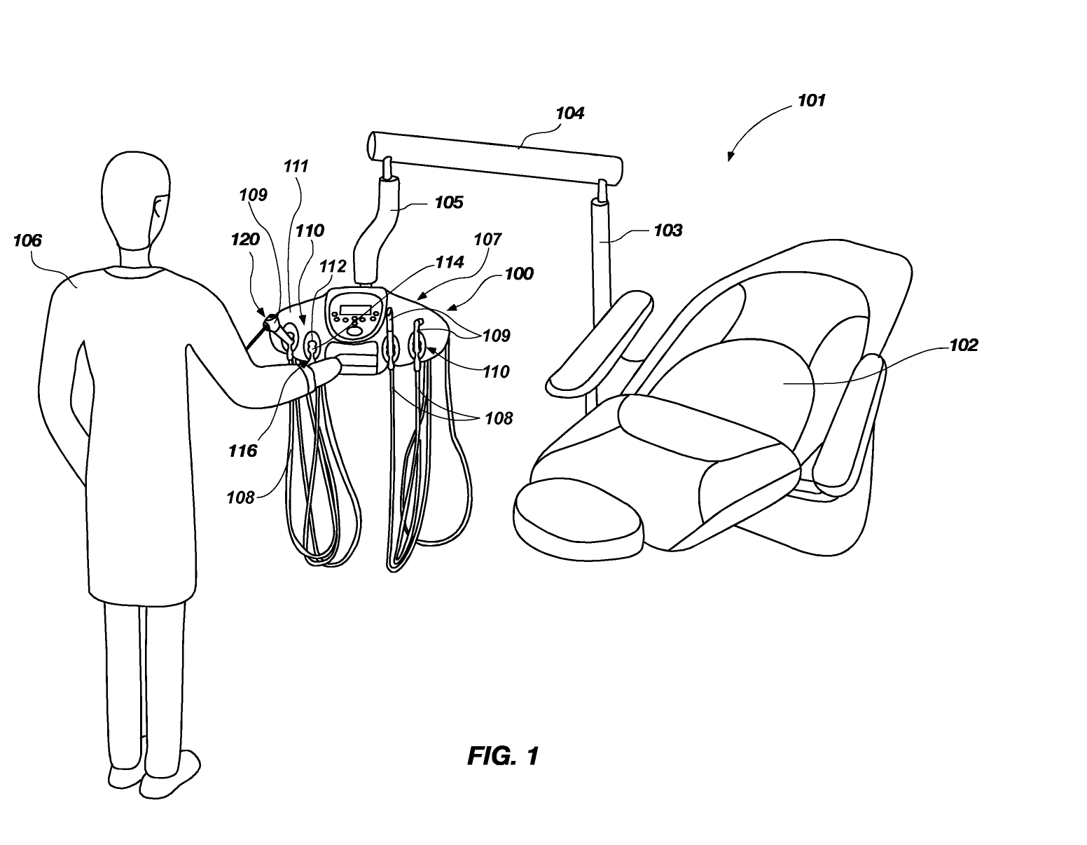

Referring to FIG. 1, a delivery unit 100 may include a multiple position hand piece “holster” or receptacle 110 according to particular embodiments of the invention. As used herein, the term “holster” is used to describe a type of receptacle, is considered to be interchangeable with the word receptacle, without material or physical limitation thereon, and is used in order to facilitate a better appreciation of the invention. Before turning to the current embodiment, the term holstering generally includes, without limitation, placing of an object into a structure that specifically supports the object in the structure. Further, a holster may include a slot, port or passage that transversely allows the object, with or without its support lines or ties, to be positioned within or through the structure and then supported by the structure.

By way of example, the delivery unit 100 may be included as part of a dental system 101 that may further include a base 103 mounted to an articulating arm 104 that is attached to a swing 105 that pivots. The base 103 may be mounted to a dental or patient chair 102. The delivery unit 100 may be coupled to the swing 105, allowing the delivery unit 100 to be conveniently positioned proximate to the dental chair 102 by a dentist 106. The delivery unit 100 may include a control panel 107 to control, support and supply the conduits 108 that are coupled to the dental hand pieces or hand-held devices 109. The supply conduits 108 may provide, for example, the supply of electricity, vacuum, water, air and/or light to the hand-held devices 109 by way of the delivery unit 100. Typically, conduits 108 terminate in quick release ends to which the hand-held devices 109 are attached. Each hand-held device 109, together with its associated conduit 108, may be coupled to a multiple position hand piece “holster” or receptacle 110 located on the delivery unit 100. In another embodiment, the receptacle 110 may be located in a “unit head” 111 (i.e., a structure for receiving medical instruments) that can be included as part of the delivery unit 100 or, alternatively, may be formed as a stand-alone structure. While the delivery unit 100 may be included as part of a dental system 101, as typically used in the dental industry, it is recognized that the delivery unit 100 may be provided as a stand-alone, self-contained device, which for example, may be independently mounted in a cabinet, mounted upon a medical cart, or be combined as part of other medical equipment. The delivery unit 100 need not be limited to use in the dental field. Further, the control panel 107, the supply conduits 108 and the hand-held devices 109 are generally known by persons of skill in the dental art. Thus, further description of those elements is not provided herein.

The multiple position hand piece receptacle 110 is also referred to as a receptacle, a tool receptacle, or a multiple position hand device receptacle herein.

Optionally, the unit head 111 may include more than one multiple position hand piece receptacles 110 in accordance with the invention and may also include an assortment of fixed position receptacles or rotating position receptacles conventionally known in the art for receiving hand-held devices 109.

The receptacle 110 includes a first seat 112, a second seat 114 and a slot 116. The first seat 112 is adjacent the second seat 114 and connected to each other by the slot 116, allowing a hand-held device 109 with its associated conduit 108 to be received into either seat 112 and 114. The first seat 112 may be oriented at a different angle, rotation, or direction from the second seat 114 in order to provide multiple positions for releasably receiving the hand-held device 109. It is recognized that additional seats may be provided within the slot 116 of the receptacle 110 to facilitate positioning flexibility placement of the hand-held device 109 by the dentist. Specifically, the hand-held device 109 is shown as positioned by the dentist into a first position 122 (e.g., at nonvertical angle and pointed toward the dentist).

Further, the receptacle 110 may be made from any suitable material, such as a metal, wood, or plastic. In a particular embodiment, the receptacle 110 can be made from a material that advantageously reduces cavities or crevasses to form an aseptic environment for the holster. Specifically, the seats 112 and 114 connected by the slot 116 can be formed from a unitary molded plastic piece in order to allow for efficient cleaning of the receptacle 110 when used in a medical environment.

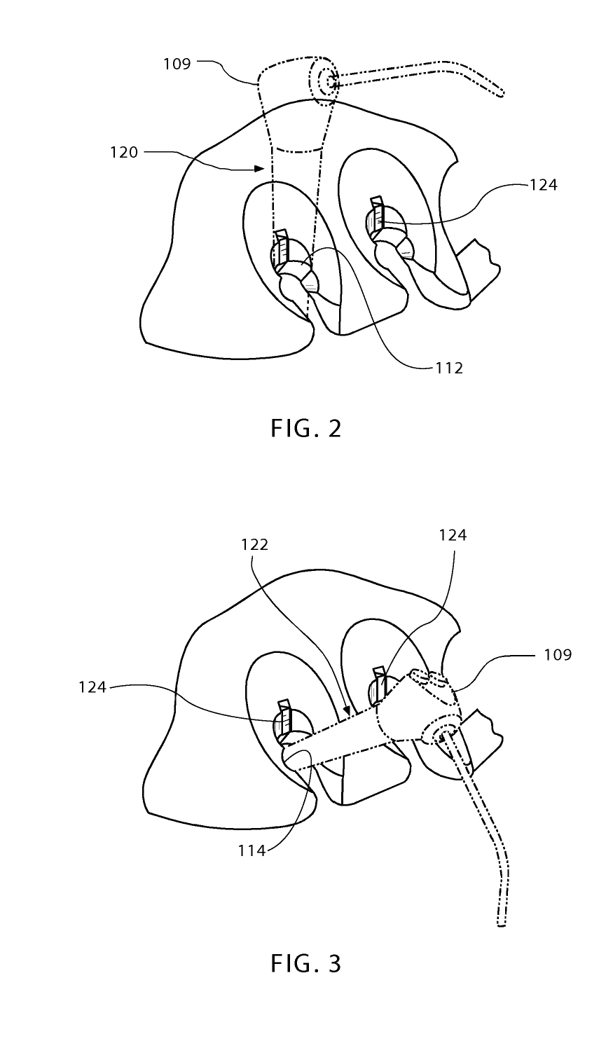

FIGS. 2 and 3 show a partial view of the multiple position hand piece receptacle 110 having a dental tool in a first position 122 (e.g., in a nonvertical position, as shown in FIG. 3) or in a second position 120 (e.g., in substantially vertical position, as shown in FIG. 2) in accordance with the embodiment of the invention. A switching element 124 may operatively be aligned with a first seat 112 and a second seat 114 in order to allow the control panel 107 to be either activated or deactivated upon activation of the switching element 124 when a hand-held device 109 is positioned into either seat 112 or 114. The activation of the control panel 107 is by the switching element 124. In order to activate or deactivate the switching element 124, the receptacle 110 may operatively associate the hand-held device 109 with the switching element 124 when inserted into either of the seats 112, 114. Specifically, the first seat 112 provides a first position 122 for the hand-held device 109 such that the hand-held device 109 will intersect or actuate the switching element 124. Likewise, the second seat 112 provides a second position 120 for the hand-held device 109 such that the hand-held device 109 will intersect or actuate the switching element 124.

In this embodiment of the invention, the switching element 124 is selectively activated by disengaging the hand-held device 109 from either of the seats 112, 114. Optionally, it is recognized that the switching element 124 may also be deactivated by removing the hand-held device 109 from either of the seats 112, 114.

The switching element 124 of this embodiment can be a single pole, single throw spring toggle switch that allows activation in one direction and deactivation in the other direction. Specifically, the seats 112 and 114 can respectively orient the hand-held device 109 into either of the first position 122 or the second position 120 such that the hand-held device 109 will substantially intersect the switching element 124 in the same place. Optionally, the switching element 124 may be, for example, a bi-directional toggle switch, a proximity sensor, an inductive or capacitive switch, a pneumatic sensor, a mechanical switch, an electronic switch, or an electromechanical switch. It should be recognized that regardless of the switching element chosen, the switching element may necessarily dictate its orientation and positioning for proper activation when a hand-held device 109 is inserted into the receptacle 110.

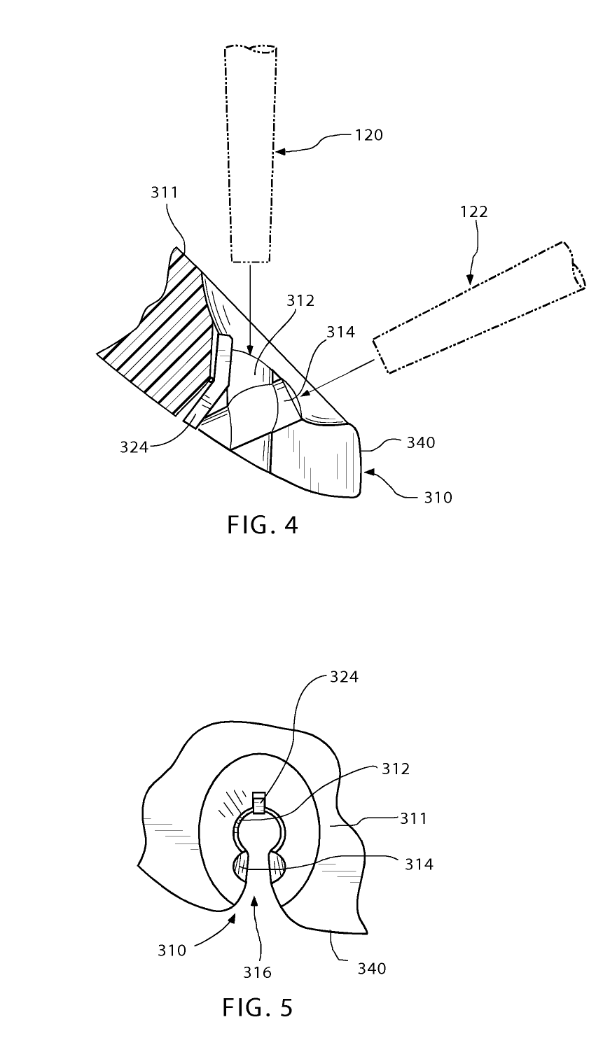

With reference to FIG. 4, a partial front view of the multiple position hand piece receptacle 310 having a dental tool (hand-held device 109) in a second position 120 is shown in accordance with another embodiment of the invention. The receptacle 310 having a first seat 312 and a second seat 314 communicatively associated with a slot 316 (shown in FIG. 5) may further include a first guide and a second guide, respectively. The first guide and the second guide can facilitate positioning of the hand-held device or dental piece (hand-held device 109) by a dentist into either of the seats 312, 314, respectively. Specifically, the first guide provides facilitation of hand-held device 109 placement into the first position 122 upon the first seat 312. Likewise, the second guide facilitates placement of the hand-held device 109 upon the second seat 314. It is recognized that there may be additional guides for additional seats to facilitate tool placement that may be included with the receptacle 310.

Also, the guides may further facilitate activation of a switching element 324 by a hand-held device 109. The switching element 324 in this embodiment is a bi-directional toggle switch. When the hand-held device 109 is inserted into the first seat 312 by way of the first guide, the switching element 324 is toggled in one direction and, upon removal of the hand-held device 109, the switching element 324 returns to its neutral position. Conversely, when the hand-held device 109 is inserted into the second seat 314 by way of the second guide, the switching element 324 is toggled in the opposite direction and, upon removal of the hand-held device 109, the switching element 324 returns once again to its neutral position. In this embodiment of the invention, the neutral position of the switching element 324 activates the control mechanism (not shown) of the delivery unit. While the functioning of the switching element 324 (e.g., the bi-directional toggle switch) in relation to the receptacle 310 is described, it is not necessary to describe the toggle switch specifically as a person of skill in the art will appreciate and understand the toggle switch utilization in the current embodiment.

To facilitate “holstering” of the hand-held device 109 upon either seat 312 or 314, one or more guides may be tapered or have a matching profile in conformity with the profile of the hand-held device 109.

Optionally, the receptacle 310 may comprise a switching element 324, wherein the first guide is coupled substantially orthogonally to the first seat 312 and substantially intersects a center of the first seat 312; and the second guide is coupled substantially orthogonally to the second seat 314 and intersects a center of the second seat 314. The axis of the first seat 312 and the second seat 314 independently converge toward the switching element 324 such that a hand-held device 109 may interact with or intersect at the switching element 324 upon removal and insertion of the hand-held device 109 into either position 120 or 122.

Optionally, the switching element 324 may be a proximity sensor having a line of sight for interaction with the first seat 312 or the second seat 314 to detect the presence of the hand-held device 109 within the receptacle 310. However, it is understood that upon placement of the hand-held device 109 into or out of the receptacle, that the first seat 312 and the second seat 314 may intersect at a switch deployment location (not shown), particularly if the switching element 324 is a mechanical switch type.

A receptacle 310 may include a slot 316, a first seat 312 and a second seat 314, as illustrated in FIG. 5, in accordance with yet another embodiment of the invention. The slot 316 can provide a common passageway in which a dental or other tool (not shown) may be removably positioned upon either of the seats 312, 314. The receptacle 310 can be included in the outer periphery 340 of a unit head 311 in order to allow the tool with its attended cables or lines (not shown) to be conveniently and easily placed upon either seat 312 or 314. The first seat 312 may include a semi-circular portion, while the second seat 314 may include two part-crescent portions. Both seats 312, 314 can be designed to provide support for the same tool in at least two different positions, as described herein. However, it is recognized that the seats may have other shapes consistent with the invention herein described.

Generally, the invention provides a multiple position receptacle for allowing a dentist or other health care professional to “holster” a tool into more than one position in order to facilitate use and ease of placing and retrieving the tool. By providing a multiple position receptacle, the bio-physiological stress upon the dentist and ease of use may be improved during tool placement/retrieval, while further maintaining the aseptic condition conventionally afforded by a single position receptacle. While the above description of the invention was described with reference to a receptacle for use with dental equipment, it is understood that the invention may also be utilized in other fields where tool placement may be facilitated while maintaining an aseptic environment.

While particular embodiments of the invention have been shown and described, numerous variations and alternative embodiments will occur to those skilled in the art. Accordingly, it is intended that the invention be limited in terms of the appended claims.

1. A dental tool receptacle comprising:
a first seat;
a second seat adjacent the first seat; and
a slot for releasably receiving a hand-held device in one of the first seat or the second seat.

2. The receptacle of claim 1, further comprising a switching element operatively aligned with the first seat and the second seat.

3. The receptacle of claim 2, wherein the switching element is selectively activated by disengagement of the hand-held device from either of the seats.

4. The receptacle of claim 2, wherein the switching element is a single pole, single throw spring toggle switch.

5. The receptacle of claim 2, wherein the switching element is selected from the group consisting of a mechanical switch, a capacitive switch, an electronic switch, a pneumatic sensor, an inductive switch, an optical switch, and an electromechanical switch.

6. The receptacle of claim 1, further comprising a plurality of seats adjacent the first seat and the second seat.

7. The receptacle of claim 1, further comprising a first guide and a second guide for releasably directing the hand-held device into one of the first seat or the second seat.

8. The receptacle of claim 7, further comprising a switching element, wherein the first guide is coupled substantially orthogonally to the first seat and having a first axial direction, the first axial direction substantially intersecting a center of the first seat, and the second guide is coupled substantially orthogonally to the second seat and having a second axial direction, the second axial direction substantially intersecting a center of the second seat, the first axial direction and the second axial direction independently converging toward the switching element facilitating interaction with the hand-held device.

9. The receptacle of claim 8, wherein the switching element is a proximity sensor.

10. The receptacle of claim 8, wherein the switching element is selected from the group consisting of a pneumatic sensor, a capacitive switch, an inductive switch, and an optical switch.

11. The receptacle of claim 8, wherein the first axial direction and the second axial direction intersect at a switch deployment location.

12. The receptacle of claim 7, wherein either of the first guide and the second guide are tapered.

13. A delivery unit comprising:
a unit head;
one or more hand-held devices operatively supported by the unit head; and
at least one multiple position hand device receptacle coupled to the unit head, each multiple position hand device receptacle configured to releasably receive one of the one or more hand-held devices.

14. The delivery unit of claim 13, wherein the at least one multiple position hand device receptacle comprises:
a plurality of seats, one of the plurality of seats being a first seat and another of the plurality of seats being a second seat, the second seat positioned adjacent the first seat; and
a slot for releasably receiving a hand-held device in one of the plurality of seats.

15. The delivery unit of claim 14, further comprising a switching element operatively aligned with one of the multiple position hand device receptacle.

16. The receptacle of claim 15, wherein the switching element is selectively activated by disengagement of the hand-held device from either of the plurality of seats.

17. The receptacle of claim 15, wherein the switching element is a spring toggle switch.

18. The receptacle of claim 15, wherein the switching element is selected from the group consisting of a capacitive switch, an inductive switch, and an optical switch.

19. The receptacle of claim 14, further comprising a matching plurality of guides for releasably directing the hand-held device into one of the plurality of seats.

20. The receptacle of claim 19, further comprising a switching element, wherein one of the matching plurality of guides comprises a first guide and a second guide, the first guide is coupled substantially orthogonally to the first seat and has a first axial direction, the first axial direction substantially intersecting a center of the first seat, and the second guide is coupled substantially orthogonally to the second seat and has a second axial direction, the second axial direction substantially intersecting a center of the second seat, the first axial direction and the second axial direction independently converging toward the switching element facilitating interaction with the hand-held device.

21. The receptacle of claim 20, wherein the switching element is a pneumatic sensor.

22. The receptacle of claim 20, wherein the first guide or the second guide are tapered, and the first axial direction and the second axial direction intersect at a switch deployment location.

23. A method of providing multiple hand piece positioning in a holster comprising:
providing a unit head;
providing one or more hand-held devices operatively supported by the unit head;
providing at least one multiple position hand device receptacle coupled to the unit head; and
receiving one of the hand-held devices in a slot of one of the multiple position hand device receptacles.

24. The method of claim 23, wherein one of the at least one multiple position hand device receptacle comprises a plurality of seats, one of the plurality of seats being a first seat and another of the plurality of seats being a second seat, the second seat adjacent the first seat, and further comprising positioning the hand-held device in either of the first seat and the second seat and deactivating the hand-held devices upon positioning.
